(19) United States
(12) Patent Application Publication
(10) Pub. No.: US 2026/0073629 A1
(43) Pub. Date: Mar. 12, 2026

(54) Method for Generating a Three-Dimensional Digital Human, Device, Electronic Apparatus, and Storage Medium

(71) Applicant: Moore Threads Technology Co., Ltd., Beijing (CN)

(72) Inventor: Chen Wang, Beijing (CN)

(73) Assignee: Moore Threads Technology Co., Ltd., Beijing (CN)

(21) Appl. No.: 19/388,691

(22) Filed: Nov. 13, 2025

Related U.S. Application Data
(63) Continuation of application No. PCT/CN2024/091541, filed on May 7, 2024.

(30) Foreign Application Priority Data
May 15, 2023 (CN) 202310544701.0

(51) Int. Cl. G06T 17/00; G06V 10/46; G06V 40/16

(52) U.S. Cl. CPC G06T 17/00; G06V 10/462; G06V 40/168

(57) ABSTRACT

The method includes: performing a key point detection on a face image to be processed to obtain first specific key point data; determining a first face feature vector corresponding to the face image to be processed; generating initial digital face data based on the first face feature vector, and updating the initial digital face data with the first specific key point data to obtain three-dimensional digital face data; and processing the three-dimensional digital face data by digital human generation software to obtain a target three-dimensional digital human.

### CROSS-REFERENCE TO RELATED APPLICATION

The present application is based upon and claims the benefit of priority of Chinese Patent Application No. 202310544701.0 filed with the CNIPA on May 15, 2023 and International Application No. PCT/CN2024/091541 filed on May 7, 2024, the entire contents of which are incorporated herein by reference.

### TECHNICAL FIELD

The present disclosure relates to the field of animation production, and in particular, to a method for generating a three-dimensional digital human, a device, an electronic apparatus, and a storage medium.

### BACKGROUND

In many industrial application scenarios such as industrial interfaces, movies, and games, there is a need to establish a three-dimensional digital human.

Usually, an engineer first reconstructs a three-dimensional digital face, and then connects the three-dimensional digital face to a three-dimensional digital body. Since the quality of the two-dimensional images is uneven, the accuracy of the three-dimensional digital face is not high. Therefore, manual face refining is still required, and the accuracy is relatively low. In addition, the efficiency of generating a three-dimensional digital human is reduced.

### SUMMARY

In view of this, the present disclosure provides a solution for generating a three-dimensional digital human, which can improve the accuracy and efficiency of generating a three-dimensional digital human.

According to an aspect of the present disclosure, there is provided a method for generating a three-dimensional digital human, including: performing key point detection on a face image to be processed to obtain first specific key point data; determining a first face feature vector corresponding to the face image to be processed; generating initial digital face data based on the first face feature vector, and updating the initial digital face data with the first specific key point data to obtain three-dimensional digital face data; and processing the three-dimensional digital face data by digital human generation software to obtain a target three-dimensional digital human.

In a possible implementation, the first specific key point data includes coordinates of first specific key points, the initial digital face data includes coordinates of initial three-dimensional face key points, and updating the initial digital face data with the first specific key point data to obtain three-dimensional digital face data includes: replacing the coordinates of the initial three-dimensional face key points corresponding to the first specific key points with the coordinates of the first specific key points, to obtain the three-dimensional digital face data.

In a possible implementation, determining a first face feature vector corresponding to the face image to be processed includes: performing a first segmentation operation on the face image to be processed to obtain a first face segmentation result; and determining the first face feature vector from the first face segmentation result.

In a possible implementation, the first face feature vector includes a first reflection feature vector, a first detail feature vector, a first posture feature vector, and a first expression feature vector, and the method further includes: obtaining a normal map based on the first detail feature vector, the first posture feature vector, and the first expression feature vector; and obtaining a texture map based on the first reflection feature vector.

In a possible implementation, the first face feature vector further includes a first shape feature vector, and generating initial digital face data based on the first face feature vector includes: obtaining the initial digital face data based on the first shape feature vector, the first posture feature vector, and the first expression feature vector.

In a possible implementation, the processing the three-dimensional digital face data by digital human generation software to obtain a target three-dimensional digital human includes: adjusting coordinates of face key points of a standard three-dimensional digital human based on the coordinates of the key points in the three-dimensional digital face data, to obtain first coordinates of face key points of the target three-dimensional digital human; and rendering the target three-dimensional digital human with the texture map and/or the normal map based on the first coordinates, to determine the target three-dimensional digital human.

In a possible implementation, the method is applied to a first neural network, and a training process for the first neural network includes: performing a first downsampling operation on an image sample to determine a third potential feature vector; performing a first upsampling operation on the third potential feature vector to determine a third face image; performing a second downsampling operation on the image sample to determine a third detail feature vector of the image sample, where the third detail feature vector represents coordinates of detail key points of a face of the image sample; performing a second upsampling operation on the third detail feature vector and the third potential feature vector to determine a fourth face image; and adjusting a parameter of the first neural network based on a first difference between the image sample and the third face image and a second difference between the image sample and the fourth face image.

In a possible implementation, the third potential feature vector includes a third camera feature vector, a third reflection feature vector, a third light feature vector, a third shape feature vector, a third posture feature vector, and a third expression feature vector of the image sample, and performing the first upsampling operation on the third potential feature vector to determine the third face image includes: performing a third upsampling operation on the third reflection feature vector to determine a sample texture map, where the sample texture map represents a color of each face key point in the image sample; performing a fourth upsampling operation on the third light feature vector to determine light information of the image sample, where the light information represents an intensity of incident light of the image sample; performing a fifth upsampling operation on the third shape feature vector, the third posture feature vector, and the third expression feature vector to determine coordinates of fourth face key points and reflected light intensities of the fourth face key points; and rendering the third camera feature vector, the light information, the sample texture map, the coordinates of the fourth face key points, and the reflected light intensities of the fourth face key points to obtain the third face image; and performing the upsampling operation on the third detail feature vector and the third potential feature vector to determine the fourth face image comprises: performing a sixth upsampling operation on the third detail feature vector, the third posture feature vector, and the third expression feature vector to determine a sample normal map, the sample normal map representing a reflected light intensity of each detail key point in the image sample; and rendering the coordinates of the fourth face key points, the reflected light intensities of the fourth face key points, the sample texture map, and the sample normal map to determine the fourth face image.

According to another aspect of the present disclosure, there is provided a device for generating a three-dimensional digital human, including:
a key point detection unit for performing key point detection on a face image to be processed to obtain first specific key point data;
a first face feature vector determining unit for determining a first face feature vector corresponding to the face image to be processed;
a three-dimensional digital face data determining unit for generating initial digital face data based on the first face feature vector, and updating the initial digital face data with the first specific key point data to obtain three-dimensional digital face data; and
a target three-dimensional digital human generation unit for processing the three-dimensional digital face data by digital human generation software, to obtain a target three-dimensional digital human.

In a possible implementation, the first specific key point data includes coordinates of first specific key points, the initial digital face data includes coordinates of initial three-dimensional face key points, and the three-dimensional digital face data determining unit includes:
a coordinate replacing unit for replacing coordinates of initial three-dimensional face key points corresponding to the first specific key points with coordinates of the first specific key points to obtain the three-dimensional digital face data.

In a possible implementation, the first face feature vector determining unit includes:
a segmentation unit for performing a first segmentation operation on the face image to be processed to obtain a first face segmentation result;
a first face feature determining sub-unit for determining the first face feature vector from the first face segmentation result.

In a possible implementation, the first face feature vector includes a first reflection feature vector, a first detail feature vector, a first posture feature vector, and a first expression feature vector, and the apparatus further includes:
a normal map generation unit for obtaining a normal map based on the first detail feature vector, the first posture feature vector, and the first expression feature vector;
a texture map generation unit for obtaining a texture map based on the first reflection feature vector.

In a possible implementation, the first face feature vector further includes a first shape feature vector, and the three-dimensional digital face data determining unit includes:
an initial digital face data generation unit, for obtaining the initial digital face data based on the first shape feature vector, the first posture feature vector, and the first expression feature vector.

In a possible implementation, the target three-dimensional digital human generation unit includes:
a first coordinate determining unit for adjusting coordinates of face key points of a standard three-dimensional digital human based on coordinates of key points in the three-dimensional digital face data, to obtain first coordinates of face key points of a target three-dimensional digital human;
a rendering unit for rendering the target three-dimensional digital human with the texture map and/or the normal map based on the first coordinates to determine the target three-dimensional digital human.

In a possible implementation, the apparatus is applied to a first neural network, and a training process for the first neural network includes:
performing a first downsampling operation on the image sample to determine a third potential feature vector;
performing a first upsampling operation on the third potential feature vector to determine a third face image;
performing a second downsampling operation on the image sample to determine a third detail feature vector of the image sample, the third detail feature vector representing coordinates of detail key points of a face of the image sample;
performing a second upsampling operation on the third detail feature vector and the third potential feature vector to determine a fourth face image;
adjusting a parameter of the first neural network based on a first difference between the image sample and the third face image and a second difference between the image sample and the fourth face image.

In a possible implementation, the third potential feature vector includes: a third camera feature vector, a third reflection feature vector, a third light feature vector, a third shape feature vector, a third posture feature vector, and a third expression feature vector of the image sample. the performing a first upsampling operation on the third potential feature vector to determine a third face image comprises:
performing a third upsampling operation on the third reflection feature vector to determine a sample texture map, the sample texture map representing a color of each face key point in the image sample;
performing a fourth upsampling operation on the third light feature vector to determine light information of the image sample, the light information representing an intensity of incident light of the image sample;
performing a fifth upsampling operation on the third shape feature vector, the third posture feature vector, and the third expression feature vector to determine coordinates of a fourth face key point and a reflected light intensity of the fourth face key point; and
rendering the third camera feature vector, the light information, the sample texture map, the coordinates of the fourth face key point, and the reflected light intensity of the fourth face key point to obtain the third face image; and
performing an upsampling operation on the third detail feature vector and the third potential feature vector to determine a fourth face image comprises:
performing a sixth upsampling operation on the third detail feature vector, the third posture feature vector, and the third expression feature vector to determine a sample normal map, wherein the sample normal map represents a reflected light intensity of each detail key point in the image sample;
rendering the coordinates of the fourth face key point, the reflected light intensity of the fourth face key point, the sample texture map, and the sample normal map to determine the fourth face image.

According to another aspect of the present disclosure, there is provided an electronic apparatus, including: a processor; and a memory for storing processor-executable instructions; wherein the processor is configured to implement the above method when executing the instructions stored in the memory.

According to another aspect of the present disclosure, there is provided a non-transient computer-readable storage medium having computer program instructions stored thereon, wherein the computer program instructions, when executed by a processor, implement the above method.

According to another aspect of the present disclosure, there is provided a computer program product, including computer-readable code or a non-transient computer-readable storage medium carrying computer-readable code, wherein when the computer-readable code is running in a processor of an electronic apparatus, the processor in the electronic apparatus executes the above method.

In the embodiments of the present disclosure, key point detection may be performed on the face image to be processed separately to obtain the first specific key points. In addition, a first face feature vector corresponding to the face image to be processed is determined. Initial digital face data is generated based on the first face feature vector. For data enhancement, the initial face data is updated with the first specific key point data, to obtain three-dimensional digital face data representing more accurate information, wherein the first specific key point data defines critical facial features, thereby improving the accuracy for subsequently generating the target three-dimensional digital human. Then, the three-dimensional digital face data is processed by the digital human generation software to obtain the target three-dimensional digital human.

Since the initial face data can be updated with the first specific key points, the accuracy of the three-dimensional digital face data is improved without manual face refining. Therefore, the accuracy and efficiency of generating a three-dimensional digital human are generally improved. Other features and aspects of the present disclosure will become apparent from the following detailed descriptions of exemplary embodiments with reference to the accompanying drawings.

### BRIEF DESCRIPTION OF THE DRAWINGS

The accompanying drawings, which are incorporated in and constitute a part of this specification, illustrate exemplary embodiments, features, and aspects of the present disclosure together with the description, and serve to explain the principles of the disclosure.

FIG. 1 is a schematic flowchart of a method for generating a three-dimensional digital human according to an embodiment of the present disclosure.

FIG. 2 provides another schematic flowchart of a method for generating a three-dimensional digital human according to an embodiment of the present disclosure.

FIG. 3 is a schematic structural diagram of a device for generating a three-dimensional digital human according to an embodiment of the present disclosure.

FIG. 4 is a schematic structural diagram of an electronic apparatus for generating a three-dimensional digital human according to an embodiment of the present disclosure.

### DETAILED DESCRIPTION

Various exemplary embodiments, features and aspects of the present disclosure will be described in detail below with reference to the accompanying drawings. The same numerical references in the drawings indicate functionally the same or similar elements. While the various aspects of the embodiments are illustrated in drawings, the drawings are not necessarily drawn to scale unless specifically indicated.

The word “exemplary” is used exclusively herein to mean “serving as an example, embodiment, or illustration. ” Any embodiment described herein as “exemplary” is not necessarily to be construed as preferred or advantageous over other embodiments.

In addition, in order to better illustrate the present disclosure, numerous specific details are given in the following particular implementations.

It will be understood by those skilled in the art that the present disclosure may be implemented without some of the specific details. In some examples, methods, means, elements and circuits well known to those skilled in the art are not described in detail, so as to highlight the subject matter of the present disclosure.

A three-dimensional digital face, which serves as the foundational structure, is generated from a provided two-dimensional image by automatically processing it with a pre-trained model. However, since the quality of two-dimensional images is uneven, the accuracy of three-dimensional digital face is not high. Although increasing the number of layers of the model can improve the accuracy of the three-dimensional digital face to a certain extent, re-modeling is needed and the cost of training the model is high. Moreover, the effect of the model is strongly correlated with the training samples, and the accuracy improvement is not obvious.

In addition, the generated three-dimensional digital face may also be adjusted by manual face refining, but the accuracy is not high. Moreover, the efficiency of generating a three-dimensional digital human is reduced.

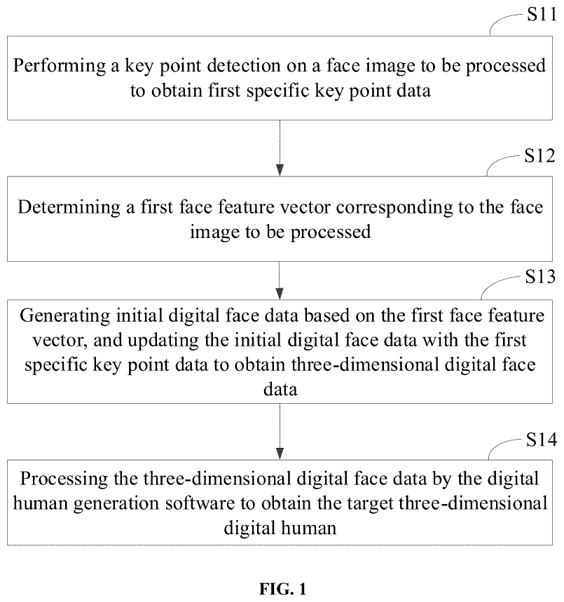

FIG. 1 is a schematic flowchart of a method for generating a three-dimensional digital human according to an embodiment of the present disclosure. As shown in FIG. 1, the method includes:
S11, performing a key point detection on a face image to be processed to obtain first specific key point data.

The face image to be processed may be a two-dimensional image including a face. The first specific key point data may be a part of key point data of the face in the face image to be processed. For example, the first specific key point data may be key point data of the organs and a face contour in the face image to be processed. The first specific key point data may represent a shape of a partial region of a three-dimensional face.

In an embodiment of the present disclosure, a specific key point data extraction model may be pre-trained; and the specific key point data extraction model may be used to perform the key point detection on the face image to be processed to obtain the first specific key point data.
S12, determining a first face feature vector corresponding to the face image to be processed.

The first face feature vector may be a feature vector representing a face in the face image to be processed. In an embodiment of the present disclosure, the first face feature vector may be extracted from the face image to be processed.
S13, generating initial digital face data based on the first face feature vector, and updating the initial digital face data with the first specific key point data to obtain three-dimensional digital face data.

The initial digital face data may represent an initial state of the three-dimensional digital face and initial light intensities at respective positions of the three-dimensional digital face. The initial state may include: an initial shape, an initial posture, and initial relative positions of the organs of the three-dimensional digital face. In an embodiment of the present disclosure, the initial digital face data may be updated with the first specific key point data, so as to update the state of the three-dimensional digital face and the light intensities at respective positions of the three-dimensional digital face to obtain the three-dimensional digital face data. The three-dimensional digital face data may represent an updated state of the three-dimensional digital face and updated light intensities at respective positions of the three-dimensional digital face. The updated state may include an updated shape, an updated posture, and updated relative positions of the organs of the three-dimensional digital face. The information represented by the three-dimensional digital face data is more accurate than the information represented by the initial digital face.
S14, processing the three-dimensional digital face data by the digital human generation software to obtain the target three-dimensional digital human.

The digital human generation software may connect the three-dimensional digital face to the three-dimensional digital body to obtain an initial three-dimensional digital human. Then, the initial three-dimensional digital human is rendered, and the light and color of the face of the initial three-dimensional digital human are updated to generate the target three-dimensional digital human.

In the embodiments of the present disclosure, key point detection may be performed on the face image to be processed separately to obtain the first specific key points. In addition, a first face feature vector corresponding to the face image to be processed is determined. Initial digital face data is generated based on the first face feature vector. In addition, the initial face data is updated with the first specific key point data, to obtain three-dimensional digital face data representing more accurate information, improving accuracy of subsequent generation of the target three-dimensional digital human. Then, the three-dimensional digital face data is processed by the digital human generation software to obtain the target three-dimensional digital human. Since the initial face data can be updated with the first specific key points, the accuracy of the three-dimensional digital face data is improved without manual face refining. Therefore, the accuracy and efficiency of generating a three-dimensional digital human are generally improved.

In a possible implementation, the first specific key point data includes coordinates of a first specific key point, the initial digital face data includes coordinates of an initial three-dimensional face key point, and updating the initial digital face data with the first specific key point data to obtain three-dimensional digital face data includes: replacing the coordinates of the initial three-dimensional face key point corresponding to the first specific key point with the coordinates of the first specific key point, to obtain the three-dimensional digital face data.

The first specific key points may be a part of the key points in the initial three-dimensional face key points. The first specific key points may be key points of face organs and face contour parts. Therefore, a part of the initial three-dimensional face key points correspond to the first specific key points. The coordinates of the first specific key points are more accurate than the coordinates of the initial three-dimensional face key points corresponding to the first specific key points. In an embodiment of the present disclosure, the coordinates of the initial three-dimensional face key points corresponding to the first specific key points may be replaced with the coordinates of the first specific key points. In this way, the accuracy of the three-dimensional digital face data can be improved.

In a possible implementation, determining a first face feature vector corresponding to the face image to be processed includes: performing a first segmentation operation on the face image to be processed to obtain a first face segmentation result; and determining the first face feature vector from the first face segmentation result.

In the image to be processed, the contrast and color of the person and the background may vary. In some images to be processed, the color of background is relatively close to that of the person; and in some images to be processed, the proportion of the person is relatively small. In this way, the background may interfere the extraction of the first face feature vector. Therefore, in a embodiment of the present disclosure, the face in the image to be processed may be segmented first. That is, a first segmentation operation is performed to obtain the first face segmentation result. Then, the first face feature vector is determined from the first face segmentation result. Therefore, the influence of the background on the extraction of the first face feature vector can be reduced, and the accuracy of determining the first face feature vector can be improved.

In a possible implementation, the first face feature vector includes a first reflection feature vector, a first detail feature vector, a first posture feature vector, and a first expression feature vector, and the method further includes: obtaining a normal map based on the first detail feature vector, the first posture feature vector, and the first expression feature vector; and obtaining a texture map based on the first reflection feature vector.

The first reflection feature vector may represent a color on each key point of the face in the image to be processed.

Human appearances may vary. By comparing some parts of persons, faces can be distinguished. For example, organs, cheek bones, face contours, and the like are compared. For ease of description below, these parts used to distinguish between faces are named as detail parts. The above is an example, and the detail parts are not limited in this embodiment.

The first detail feature vector may represent coordinates of key points of a detail part of the face in the image to be processed. The first posture feature vector may represent the orientation of the face in the image to be processed and a position offset angle relative to a standard head. The first expression feature vector may represent a mapping relationship between respective key points of the face in the image to be processed and key points of standard face.

In an embodiment of the present disclosure, the first detail feature vector, the first posture feature vector, and the first expression feature vector may be spliced as a whole, that is, a first spliced vector. The first spliced vector is upsampled to obtain the normal map. The normal map may present the reflected light intensity on each key point of the face represented by the three-dimensional digital face data.

In addition, the first reflection feature vector may be processed, for example, an upsampling operation is performed on the first reflection feature vector to obtain a texture map. The texture map may present a color on each key point of the face represented by the three-dimensional digital face data.

The positions of the detail parts of the face, the orientation and rotation angle of the face, and the expressions of the face all may affect the reflected light intensities of respective key points on the face. Therefore, the first detail feature vector, the first posture feature vector, and the first expression feature vector may be processed; to improve accuracy of determined the normal map. In addition, the texture map may be obtained directly based on the first reflection feature vector, to improve efficiency of obtaining the texture map.

In a possible implementation, the first face feature vector further includes a first shape feature vector, and generating initial digital face data based on the first face feature vector includes: obtaining the initial digital face data based on the first shape feature vector, the first posture feature vector, and the first expression feature vector.

The first shape feature vector may represent the contour of the face in the image to be processed, and the contour of each part of the face, such as the contours of the organs, cheeks, forehead, and the positional relationships of the respective parts of the face.

In an embodiment of the present disclosure, the first shape feature vector, the first posture feature vector, and the first expression feature vector may be spliced as a whole, that is, a second spliced vector. The second spliced vector is upsampled to obtain the initial digital face data. Because the shape, posture, and expression of the face in the to-be-processed image are integrated, accuracy of the initial digital face data is improved.

In a possible implementation, the processing the three-dimensional digital face data by digital human generation software to obtain a target three-dimensional digital human includes: adjusting coordinates of face key points of a standard three-dimensional digital human based on the coordinates of the key points in the three-dimensional digital face data, to obtain first coordinates of face key points of the target three-dimensional digital human; and rendering the target three-dimensional digital human with the texture map and/or the normal map based on the first coordinates, to determine the target three-dimensional digital human.

The standard three-dimensional digital human may be a pre-generated three-dimensional digital human. The standard three-dimensional digital human includes a standard three-dimensional face and a standard three-dimensional body. The standard three-dimensional human face may be composed of face key points. By changing the coordinates of the face key points of the standard three-dimensional face, the shape, posture, expression, etc. of the standard three-dimensional face can be changed. The face key points of the standard three-dimensional face may be in one-to-one correspondence with the key points in the three-dimensional digital face data. In an embodiment of the present disclosure, the coordinates of the face key points of the standard three-dimensional digital human may be adjusted based on the coordinates of the key points in the three-dimensional digital face data. After the adjustment, the first coordinates of the face key points of the target three-dimensional digital human may be obtained. The respective first coordinates are the same as coordinates of corresponding key points in the three-dimensional digital face data. That is, the face of the standard three-dimensional face is automatically adjusted to the three-dimensional face represented by the three-dimensional digital face data, thereby improving the efficiency.

In addition, the respective first coordinates are the same as the coordinates of the corresponding key points in the three-dimensional digital face data, the normal map may present the reflected light intensity on each key point of the face represented by the three-dimensional digital face data, and the texture map may present the color on each key point of the face represented by the three-dimensional digital face data. Therefore, the face of the target three-dimensional digital human may be rendered with the texture map and/or the normal map based on the first coordinates to determine the target three-dimensional digital human.

In a possible implementation, the method is applied to a first neural network, that is, a first face feature vector is extracted by the first neural network, or further, by the first neural network, the first face feature vector is extracted and corresponding initial digital face data is generated. The first neural network may be pre-trained, or it may be understood that the first neural network may be first trained before inference is performed by the first neural network. Specifically, a training process for the first neural network includes: performing a first downsampling operation on an image sample to determine a third potential feature vector; performing a first upsampling operation on the third potential feature vector to determine a third face image; performing a second downsampling operation on the image sample to determine a third detail feature vector of the image sample, where the third detail feature vector represents coordinates of detail key points of a face of the image sample; performing a second upsampling operation on the third detail feature vector and the third potential feature vector to determine a fourth face image; and adjusting a parameter of the first neural network based on a first difference between the image sample and the third face image and a second difference between the image sample and the fourth face image.

The specific type of the first neural network is not limited, and may be, for example, a convolutional neural network, a recurrent neural network, and the like. The first neural network may include a plurality of encoders and a plurality of decoders, each encoder and decoder cooperate with each other, and output data of different encoders and decoders may represent a physical meaning of an input image in a certain aspect, such as light, reflection, shape, posture, details, etc. In a feasible implementation, the third potential feature may be considered as a face feature vector corresponding to the image sample extracted by the first neural network based on the current network parameter; in another implementation, the third potential feature vector may cooperate with the third detail feature vector to generate a face feature vector corresponding to the image sample extracted by the first neural network based on the current network parameter; in another implementation, after being processed by the decoder based on the third potential feature vector, or based on the third potential feature vector and the third detail feature vector, initial digital face data extracted by the first neural network based on the current network parameter is obtained. The third potential feature vector may be a low-dimensional feature vector. The third potential feature may represent a feature of the image sample, and may include a feature of the image per se; a feature of a face in the image, for example, a pose, a shape, an expression of the face; and a reflected light intensity feature of each face key point determined based on the pose, the shape, the expression of the face. The face detail key points of the image sample may be a part of the face key points of the image sample and located at detail parts of the face of the image sample.

In an embodiment of the present disclosure, on the one hand, the third potential feature vector is determined by performing the first downsampling operation on the image sample, and then the third face image is determined by performing the first upsampling operation on the third potential feature vector. In another aspect, a second upsampling operation is performed on the image sample to determine a third detail feature vector; and a second upsampling operation is performed on the third detail feature vector and the third potential feature vector to determine a fourth face image, wherein the third face image may be a two-dimensional image, and the fourth face image may be a two-dimensional image. The fourth face image is more accurate in face details than the third face image. Here, the first downsampling and the second downsampling may be different; and the first upsampling and the second upsampling may be different.

Actually, the third face image may be a reconstructed image sample. The fourth face image is another reconstructed image sample. Therefore, the closer the third face image and the fourth face image are to the image sample, the higher the accuracy of the first neural network is. Therefore, the parameter of the first neural network may be adjusted based on the first difference between the image sample and the third face image and the second difference between the image sample and the fourth face image.

In this way, the trained first neural network can not only accurately represent a contour, a shape, and a posture of a face, but also accurately represent feature of detail parts of the face, improving accuracy of the first neural network.

In a possible implementation, the third detail feature vector includes at least one of: a nose detail feature vector, an eye corner detail feature vector, a mouth corner detail feature vector, a chin detail feature vector, a forehead detail feature vector, and a cheekbone detail feature vector.

There may be a large difference between the face in the image sample and the face in the input image in actual use. For example, the face in the image sample is the face of a western person, while the face in the input image is a face of an Asian. Therefore, even if accuracy of the first neural network meets a requirement in the training process, it is still possible that the accuracy of the first neural network may be reduced in use.

Regardless of different races or individuals, there will be obvious differences in the nose, corners of eyes, corners of mouth, chin, forehead, and cheek bones. Detail parts are defined by specifically identifying facial landmarks including the nose, eye corners, mouth corners, chin, forehead, and cheekbones; and one or more feature vectors corresponding to these defined detail parts are utilized as the third detail feature vector, thereby reducing the accuracy's dependency on a single image sample and improving the stability and universality of the first neural network.

In a possible implementation, the third potential feature vector includes a third camera feature vector, a third reflection feature vector, a third light feature vector, a third shape feature vector, a third posture feature vector, and a third expression feature vector of the image sample, and performing the first upsampling operation on the third potential feature vector to determine the third face image includes: performing a third upsampling operation on the third reflection feature vector to determine a sample texture map, where the sample texture map represents a color of each face key point in the image sample; performing a fourth upsampling operation on the third light feature vector to determine light information of the image sample, where the light information represents an intensity of incident light of the image sample; performing a fifth upsampling operation on the third shape feature vector, the third posture feature vector, and the third expression feature vector to determine coordinates of fourth face key points and reflected light intensities of the fourth face key points; and rendering the third camera feature vector, the light information, the sample texture map, the coordinates of the fourth face key points, and the reflected light intensities of the fourth face key points to obtain the third face image; and performing the upsampling operation on the third detail feature vector and the third potential feature vector to determine the fourth face image comprises: performing a sixth upsampling operation on the third detail feature vector, the third posture feature vector, and the third expression feature vector to determine a sample normal map, the sample normal map representing a reflected light intensity of each detail key point in the image sample; and rendering the coordinates of the fourth face key points, the reflected light intensities of the fourth face key points, the sample texture map, and the sample normal map to determine the fourth face image.

The third camera feature vector may represent an angle and a distance of the image acquisition device that acquires the image sample relative to the acquired object. The third reflection feature vector may represent a color of each key point of the face in the image sample. The third light feature vector may represent an intensity and an angle of incident light when the image sample is captured. The third shape feature vector may represent coordinates of the key point of the fourth three-dimensional face corresponding to the face in the image sample (i.e., the coordinates of the fourth face key point). The third shape feature vector may represent the contour of the face and the contour of the organs of the face in the image sample. The third posture feature vector may represent an overall orientation of the face in the image sample, and an offset and a rotation angle relative to the standard face. The third expression feature vector may represent an offset of each part of the face in the image sample relative to the corresponding part of the standard face, and the positional relationships of the respective parts of the face in the image sample.

In an embodiment of the present disclosure, the coordinates of the fourth face key points and the reflected light intensities on the fourth face key points may be determined with the third shape feature vector, the third posture feature vector, and the third expression feature vector. Therefore, the fourth three-dimensional face represented by the fourth face key points not only presents the shape, posture, and expression of the face in the image sample, but also presents the light intensities of the respective parts of the face in the image sample. The coordinates of the fourth face key point are three-dimensional coordinates.

Additionally, a sample texture map, which represents the color of the fourth face key point, is determined by processing the third reflection feature vector; and then rendering is performed for image synthesis based on the third camera feature vector, the light information, the sample texture map, the coordinates of the fourth face key points, and the reflected light intensities of the fourth face key points, to determine the third face image.

The third detail feature vector represents coordinates of a detail key point of the face in the image sample. In an embodiment of the present disclosure, a sample normal map representing the reflected light intensity of each detail key point in the image sample can be determined with the third detail feature vector, the third pose feature vector, and the third expression feature vector. In addition, the coordinates of the fourth face key point, the reflected light intensities of the fourth face key point, and the sample normal map are rendered to obtain the coordinates of the fifth face key point and the reflected light intensity of the fifth face key point. The fifth face key points represent a fifth three-dimensional face. The fifth three-dimensional face can more accurately present the features of the detail parts of the face in the image sample than the fourth three-dimensional face. In addition, the coordinates of the fifth face key points, the reflected light intensities of the fifth face key points, and the sample texture map may be rendered to determine the fourth face image.

In an embodiment of the present disclosure, the image sample, the third face image, and the fourth face image are all two-dimensional images. The embodiment of the present disclosure includes two stages: a stage for generating the third face image and a stage for generating the fourth face image. In the stage for generating the third face image, attention is paid to the overall shape, posture, expression and color of the face in the image sample. In the stage for generating the fourth face image, attention is paid on the features of the detail parts of the face in the image sample. In addition, influence of the detail features on the overall shape, posture, and expression of the face is presented in the fourth image. Therefore, by adjusting the parameters of the first neural network using the respective differences (the first difference and the second difference) between the third face image and the image sample and between the fourth face image and the image sample, the accuracy of generating the three-dimensional face can be improved on the whole and in the details.

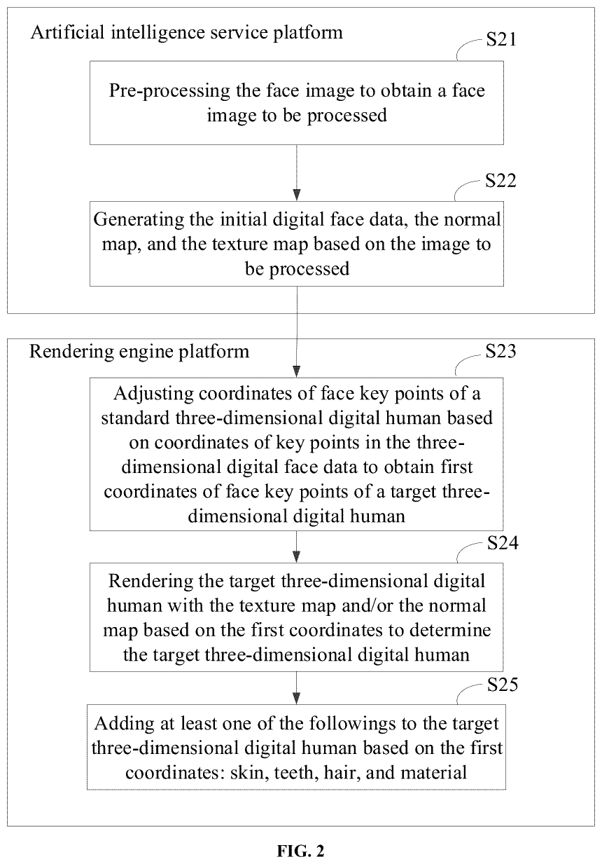

FIG. 2 provides another schematic flowchart of a method for generating a three-dimensional digital human according to an embodiment of the present disclosure. As shown in FIG. 2, in a process of generating a target three-dimensional digital human, an artificial intelligence service platform and a rendering engine platform need to be used.

In the artificial intelligence service platform, the following operations are performed:
S21: pre-processing the face image to obtain a face image to be processed, where the pre-processing may include performing operations such as attribute editing and image augmentation on the face image;
S22, generating the initial digital face data, the normal map, and the texture map based on the image to be processed;

The following operations are performed on the rendering engine platform:
S23, adjusting coordinates of face key points of a standard three-dimensional digital human based on coordinates of key points in the three-dimensional digital face data to obtain first coordinates of face key points of a target three-dimensional digital human;
S24, rendering the target three-dimensional digital human with the texture map and/or the normal map based on the first coordinates to determine the target three-dimensional digital human;
S25: adding at least one of the followings to the target three-dimensional digital human based on the first coordinates: skin, teeth, hair, and material.

FIG. 3 is a schematic structural diagram of a device for generating three-dimensional digital human apparatus according to an embodiment of the present disclosure. The apparatus 30 includes:
the key point detection unit 31 for performing key point detection on the face image to be processed to obtain first specific key point data;
the first face feature vector determining unit 32 for determining a first face feature vector corresponding to the face image to be processed;
the three-dimensional digital face data determining unit 33 for generating initial digital face data based on the first face feature vector, and updating the initial digital face data with the first specific key point data to obtain three-dimensional digital face data; and
the target three-dimensional digital human generation unit 34 for processing the three-dimensional digital face data by digital human generation software, to obtain a target three-dimensional digital human.

In a possible implementation, the first specific key point data includes coordinates of first specific key points, the initial digital face data includes coordinates of initial three-dimensional face key points, and the three-dimensional digital face data determining unit 33 includes:
a coordinate replacing unit for replacing coordinates of initial three-dimensional face key points corresponding to the first specific key points with coordinates of the first specific key points to obtain the three-dimensional digital face data.

In a possible implementation, the first face feature vector determining unit 32 includes:
a segmentation unit for performing a first segmentation operation on the face image to be processed to obtain a first face segmentation result;
a first face feature determining sub-unit for determining the first face feature vector from the first face segmentation result.

In a possible implementation, the first face feature vector includes a first reflection feature vector, a first detail feature vector, a first posture feature vector, and a first expression feature vector, and the apparatus 30 further includes:
a normal map generation unit for obtaining a normal map based on the first detail feature vector, the first posture feature vector, and the first expression feature vector;
a texture map generation unit for obtaining a texture map based on the first reflection feature vector.

In a possible implementation, the first face feature vector further includes a first shape feature vector, and the three-dimensional digital face data determining unit 33 includes:
an initial digital face data generation unit, for obtaining the initial digital face data based on the first shape feature vector, the first posture feature vector, and the first expression feature vector.

In a possible implementation, the target three-dimensional digital human generation unit 34 includes:
a first coordinate determining unit for adjusting coordinates of face key points of a standard three-dimensional digital human based on coordinates of key points in the three-dimensional digital face data, to obtain first coordinates of face key points of a target three-dimensional digital human;
a rendering unit for rendering the target three-dimensional digital human with the texture map and/or the normal map based on the first coordinates to determine the target three-dimensional digital human.

In a possible implementation, the apparatus 30 is applied to a first neural network, and a training process for the first neural network includes:
performing a first downsampling operation on the image sample to determine a third potential feature vector;
performing a first upsampling operation on the third potential feature vector to determine a third face image;
performing a second downsampling operation on the image sample to determine a third detail feature vector of the image sample, the third detail feature vector representing coordinates of detail key points of a face of the image sample;
performing a second upsampling operation on the third detail feature vector and the third potential feature vector to determine a fourth face image;
adjusting a parameter of the first neural network based on a first difference between the image sample and the third face image and a second difference between the image sample and the fourth face image.

In a possible implementation, the third potential feature vector includes: a third camera feature vector, a third reflection feature vector, a third light feature vector, a third shape feature vector, a third posture feature vector, and a third expression feature vector of the image sample.

The performing a first upsampling operation on the third potential feature vector to determine a third face image comprises:
performing a third upsampling operation on the third reflection feature vector to determine a sample texture map, the sample texture map representing a color of each face key point in the image sample;
performing a fourth upsampling operation on the third light feature vector to determine light information of the image sample, the light information representing an intensity of incident light of the image sample;
performing a fifth upsampling operation on the third shape feature vector, the third posture feature vector, and the third expression feature vector to determine coordinates of a fourth face key point and a reflected light intensity of the fourth face key point; and
rendering the third camera feature vector, the light information, the sample texture map, the coordinates of the fourth face key point, and the reflected light intensity of the fourth face key point to obtain the third face image; and
performing an upsampling operation on the third detail feature vector and the third potential feature vector to determine a fourth face image comprises:
performing a sixth upsampling operation on the third detail feature vector, the third posture feature vector, and the third expression feature vector to determine a sample normal map, wherein the sample normal map represents a reflected light intensity of each detail key point in the image sample;
rendering the coordinates of the fourth face key point, the reflected light intensity of the fourth face key point, the sample texture map, and the sample normal map to determine the fourth face image.

In some embodiments, functions or modules of the device provided in the embodiments of the present disclosure may be used to perform the method described in the above method embodiments, and for specific implementation thereof, reference may be made to the description of the above method embodiments, which will not be repeated here for brevity.

An embodiment of the present disclosure further provides a computer-readable storage medium having computer program instructions stored thereon, wherein the computer program instructions, when executed by a processor, implement the above method. The computer-readable storage medium may be a transient or non-transient computer-readable storage medium.

An embodiment of the present disclosure further provides an electronic apparatus, including: a processor; and a memory for storing processor-executable instructions, where the processor is configured to implement the above method when executing the instructions stored in the memory.

An embodiment of the present disclosure further provides a computer program product, including computer-readable code or a non-transient computer-readable storage medium carrying computer-readable code, wherein when the computer-readable code is running in a processor of an electronic apparatus, the processor in the electronic apparatus executes the foregoing method.

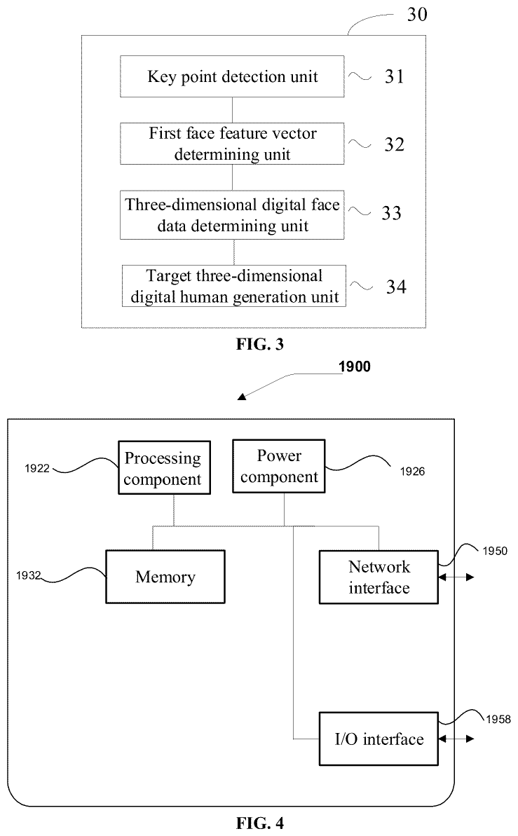

FIG. 4 is a schematic structural diagram of an electronic apparatus for generating a three-dimensional digital human according to an embodiment of the present disclosure. For example, the electronic apparatus 1900 may be provided as a server or a terminal device. Referring to FIG. 4, the electronic apparatus 1900 includes a processing component 1922, which further includes one or more processors, and memory resources represented by a memory 1932 for storing instructions executable by the processing component 1922, such as application programs. The application program stored in the memory 1932 may include one or more modules each corresponding to a set of instructions. In addition, the processing component 1922 is configured to execute instructions to perform the above method.

The electronic apparatus 1900 may further include a power component 1926 configured to perform power management of the electronic apparatus 1900, a wired or wireless network interface 1950 configured to connect the electronic apparatus 1900 to a network, and an input/output interface 1958 (I/O interface). The electronic apparatus 1900 may operate based on an operating system stored in the memory 1932, such as Windows Server™, Mac OS X™, Unix™, Linux™, FreeBSD™ or the like.

In an exemplary embodiment there is further provided a non-transitory computer readable storage medium, such as the memory 1932 that includes computer program instructions. The computer program instructions may be executed by the processing assembly 1922 of the electronic apparatus 1900 to implement the above methods.

The present disclosure may be a system, a method, and/or a computer program product. The computer program product may include a computer readable storage medium carrying computer readable program instructions for causing a processor to implement the aspects of the present disclosure.

The computer readable storage medium can be a tangible device that can retain and store instructions used by an instruction executing device. The computer readable storage medium may be, but not limited to, e.g., electronic storage device, magnetic storage device, optical storage device, electromagnetic storage device, semiconductor storage device, or any proper combination thereof. A non-exhaustive list of more specific examples of the computer readable storage medium includes: portable computer diskette, hard disk, random access memory (RAM), read-only memory (ROM), erasable programmable read-only memory (EPROM or Flash memory), static random access memory (SRAM), portable compact disc read-only memory (CD-ROM), digital versatile disk (DVD), memory stick, floppy disk, mechanically encoded device (for example, punch-cards or raised structures in a groove having instructions recorded thereon), and any proper combination thereof. A computer readable storage medium referred herein should not to be construed as transitory signal per se, such as radio waves or other freely propagating electromagnetic waves, electromagnetic waves propagating through a waveguide or other transmission media (e.g., light pulses passing through a fiber-optic cable), or electrical signal transmitted through a wire.

Computer readable program instructions described herein can be downloaded to individual computing/processing devices from a computer readable storage medium or to an external computer or secondary storage device via network, for example, the Internet, local area network, wide area network and/or wireless network. The network may comprise copper transmission cables, optical fiber transmission, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium in the respective computing/processing devices.

Computer program instructions for carrying out the operations of the present disclosure may be assembler instructions, instruction-set-architecture (ISA) instructions, machine instructions, machine-related instructions, microcode, firmware instructions, state-setting data, or source code or object code written in any combination of one or more programming languages, including an object oriented programming language, such as Smalltalk, C++, or the like, and the conventional procedural programming languages, such as the “C” programming language or similar programming languages. The computer readable program instructions may be executed completely on the user's computer, partly on the user's computer, as a stand-alone software package, partly on the user's computer and partly on a remote computer, or completely on a remote computer or a server. In the scenario with remote computer, the remote computer may be connected to the user's computer through any type of network, including local area network (LAN) or wide area network (WAN), or connected to an external computer (for example, connected through the Internet from an Internet Service Provider). In some embodiments, electronic circuitry, such as programmable logic circuitry, field-programmable gate arrays (FPGA), or programmable logic arrays (PLA), may be customized from state information of the computer readable program instructions; the electronic circuitry may execute the computer readable program instructions, so as to achieve the aspects of the present disclosure.

Aspects of the present disclosure have been described herein with reference to the flowchart and/or the block diagrams of the method, device (systems), and computer program product according to the embodiments of the present disclosure. It will be appreciated that each block in the flowchart and/or the block diagram, and combinations of blocks in the flowchart and/or block diagram, can be implemented by the computer readable program instructions.

These computer readable program instructions may be provided to a processor of a general purpose computer, a dedicated computer, or other programmable data processing apparatuses, to produce a machine, such that the instructions create means for implementing the functions/acts specified in one or more blocks in the flowchart and/or block diagram when executed by the processor of the computer or other programmable data processing apparatuses. These computer readable program instructions may also be stored in a computer readable storage medium, wherein the instructions cause a computer, a programmable data processing apparatus and/or other devices to function in a particular manner, such that the computer readable storage medium having instructions stored therein comprises a product that includes instructions implementing aspects of the functions/acts specified in one or more blocks in the flowchart and/or block diagram.

The computer readable program instructions may also be loaded onto a computer, other programmable data processing apparatuses, or other devices to have a series of operational steps performed on the computer, other programmable apparatuses or other devices, so as to produce a computer implemented processes, such that the instructions executed on the computer, other programmable apparatuses or other devices implement the functions/acts specified in one or more blocks in the flowchart and/or block diagram.

The flowcharts and block diagrams in the drawings illustrate the systematic architecture, function, and operation that may be implemented by the system, method and computer program product according to the various embodiments of the present disclosure. In this regard, each block in the flowchart or block diagram may represent a part of a module, a program segment, or instruction, which comprises one or more executable instructions for implementing the specified logical function(s). In some alternative implementations, the functions denoted in the blocks may occur in an order different from that denoted in the drawings. For example, two contiguous blocks may, in fact, be executed substantially parallel, or sometimes they may be executed in a reversed order, depending upon the functions involved. It will also be noted that each block in the block diagram and/or flowchart, and combinations of blocks in the block diagram and/or flowchart, can be implemented by dedicated hardware-based systems executing the specified functions or acts, or by combinations of dedicated hardware and computer instructions.

Although the embodiments of the present disclosure have been described above, it will be appreciated that the above descriptions are merely exemplary, but not exhaustive; and that the disclosed embodiments are not limiting. A number of variations and modifications may apparently occur to those of ordinary skill in the art without departing from the scopes and spirits of the described embodiments. The terms in the present disclosure are selected to provide the best explanation on the principles and practical applications of the embodiments or the technical improvements to the arts on market, or to make the embodiments described herein understandable to those of ordinary skill in the art.

What is claimed is:

1. A method for generating a three-dimensional digital human, comprising:
performing a key point detection on a face image to be processed to obtain first specific key point data;
determining a first face feature vector corresponding to the face image to be processed;
generating initial digital face data based on the first face feature vector, and updating the initial digital face data with the first specific key point data to obtain three-dimensional digital face data; and
processing the three-dimensional digital face data by digital human generation software, to obtain a target three-dimensional digital human.

2. The method according to claim 1, wherein the first specific key point data comprises coordinates of first specific key points, the initial digital face data comprises coordinates of initial three-dimensional face key points, and updating the initial digital face data with the first specific key point data to obtain the three-dimensional digital face data comprises:
replacing coordinates of initial three-dimensional face key points corresponding to the first specific key points with coordinates of the first specific key points to obtain the three-dimensional digital face data.

3. The method according to claim 1, wherein determining the first face feature vector corresponding to the face image to be processed comprises:
performing a first segmentation operation on the face image to be processed to obtain a first face segmentation result; and
determining the first face feature vector from the first face segmentation result.

4. The method according to claim 1, wherein the first face feature vector comprises: a first reflection feature vector, a first detail feature vector, a first posture feature vector, and a first expression feature vector, and the method further comprises:
obtaining a normal map based on the first detail feature vector, the first posture feature vector, and the first expression feature vector; and
obtaining a texture map based on the first reflection feature vector.

5. The method according to claim 4, wherein the first face feature vector further comprises a first shape feature vector, and generating the initial digital face data based on the first face feature vector comprises:
obtaining the initial digital face data based on the first shape feature vector, the first posture feature vector, and the first expression feature vector.

6. The method according to claim 4, wherein processing the three-dimensional digital face data by the digital human generation software to obtain a target three-dimensional digital human comprises:
adjusting coordinates of face key points of a standard three-dimensional digital human based on coordinates of key points in the three-dimensional digital face data to obtain first coordinates of face key points of a target three-dimensional digital human; and
rendering the target three-dimensional digital human with the texture map and/or the normal map based on the first coordinates to determine the target three-dimensional digital human.

7. The method according to claim 1, wherein the first face feature vector or the initial digital face data is generated by a first neural network, and a training process for the first neural network comprises:
performing a first downsampling operation on an image sample by using the first neural network to determine a third potential feature vector;
performing a first upsampling operation on the third potential feature vector to determine a third face image;
performing a second downsampling operation on the image sample using the first neural network to determine a third detail feature vector of the image sample, the third detail feature vector representing coordinates of detail key points of a face of the image sample;
performing a second upsampling operation on the third detail feature vector and the third potential feature vector to determine a fourth face image; and
adjusting a parameter of the first neural network based on a first difference between the image sample and the third face image and a second difference between the image sample and the fourth face image.

8. The method according to claim 7, wherein the third potential feature vector comprises: a third camera feature vector, a third reflection feature vector, a third light feature vector, a third shape feature vector, a third posture feature vector, and a third expression feature vector of the image sample,
performing the first upsampling operation on the third potential feature vector to determine a third face image comprises:
performing a third upsampling operation on the third reflection feature vector to determine a sample texture map, the sample texture map representing a color of each face key point in the image sample;
performing a fourth upsampling operation on the third light feature vector to determine light information of the image sample, the light information representing an intensity of incident light of the image sample;
performing a fifth upsampling operation on the third shape feature vector, the third posture feature vector, and the third expression feature vector to determine coordinates of a fourth face key point and a reflected light intensity of the fourth face key point; and
rendering the third camera feature vector, the light information, the sample texture map, the coordinates of the fourth face key point, and the reflected light intensity of the fourth face key point to obtain the third face image; and
performing the second upsampling operation on the third detail feature vector and the third potential feature vector to determine a fourth face image comprises:
performing a sixth upsampling operation on the third detail feature vector, the third posture feature vector, and the third expression feature vector to determine a sample normal map, wherein the sample normal map represents a reflected light intensity of each detail key point in the image sample; and
rendering the coordinates of the fourth face key point, the reflected light intensity of the fourth face key point, the sample texture map, and the sample normal map to determine the fourth face image.

9. An electronic apparatus, comprising:
a processor;
a memory for storing processor-executable instructions;
wherein the processor is configured to execute the instructions stored in the memory to:
perform a key point detection on a face image to be processed to obtain first specific key point data;
determine a first face feature vector corresponding to the face image to be processed;
generate initial digital face data based on the first face feature vector, and updating the initial digital face data with the first specific key point data to obtain three-dimensional digital face data; and
process the three-dimensional digital face data by digital human generation software, to obtain a target three-dimensional digital human.

10. The electronic apparatus according to claim 9, wherein the first specific key point data comprises coordinates of first specific key points, the initial digital face data comprises coordinates of initial three-dimensional face key points, and the processor is further configured to:
replace coordinates of initial three-dimensional face key points corresponding to the first specific key points with coordinates of the first specific key points to obtain the three-dimensional digital face data.

11. The electronic apparatus according to claim 9, wherein the processor is further configured to:
perform a first segmentation operation on the face image to be processed to obtain a first face segmentation result; and
determine the first face feature vector from the first face segmentation result.

12. The electronic apparatus according to claim 9, wherein the first face feature vector comprises: a first reflection feature vector, a first detail feature vector, a first posture feature vector, and a first expression feature vector, and the processor is further configured to:
obtain a normal map based on the first detail feature vector, the first posture feature vector, and the first expression feature vector; and
obtain a texture map based on the first reflection feature vector.

13. The electronic apparatus according to claim 12, wherein the first face feature vector further comprises a first shape feature vector, and the processor is further configured to:
obtain the initial digital face data based on the first shape feature vector, the first posture feature vector, and the first expression feature vector.

14. The electronic apparatus according to claim 12, wherein the processor is further configured to:
adjust coordinates of face key points of a standard three-dimensional digital human based on coordinates of key points in the three-dimensional digital face data to obtain first coordinates of face key points of a target three-dimensional digital human; and
render the target three-dimensional digital human with the texture map and/or the normal map based on the first coordinates to determine the target three-dimensional digital human.

15. The electronic apparatus according to claim 9, wherein the first face feature vector or the initial digital face data is generated by a first neural network, and a training process for the first neural network comprises:
performing a first downsampling operation on an image sample by using the first neural network to determine a third potential feature vector;
performing a first upsampling operation on the third potential feature vector to determine a third face image;
performing a second downsampling operation on the image sample using the first neural network to determine a third detail feature vector of the image sample, the third detail feature vector representing coordinates of detail key points of a face of the image sample;
performing a second upsampling operation on the third detail feature vector and the third potential feature vector to determine a fourth face image; and
adjusting a parameter of the first neural network based on a first difference between the image sample and the third face image and a second difference between the image sample and the fourth face image.

16. The electronic apparatus according to claim 9, wherein the third potential feature vector comprises: a third camera feature vector, a third reflection feature vector, a third light feature vector, a third shape feature vector, a third posture feature vector, and a third expression feature vector of the image sample,
the processor is further configured to:
perform a third upsampling operation on the third reflection feature vector to determine a sample texture map, the sample texture map representing a color of each face key point in the image sample;
perform a fourth upsampling operation on the third light feature vector to determine light information of the image sample, the light information representing an intensity of incident light of the image sample;
perform a fifth upsampling operation on the third shape feature vector, the third posture feature vector, and the third expression feature vector to determine coordinates of a fourth face key point and a reflected light intensity of the fourth face key point; and
render the third camera feature vector, the light information, the sample texture map, the coordinates of the fourth face key point, and the reflected light intensity of the fourth face key point to obtain the third face image; and
performing the second upsampling operation on the third detail feature vector and the third potential feature vector to determine a fourth face image comprises:
performing a sixth upsampling operation on the third detail feature vector, the third posture feature vector, and the third expression feature vector to determine a sample normal map, wherein the sample normal map represents a reflected light intensity of each detail key point in the image sample; and
rendering the coordinates of the fourth face key point, the reflected light intensity of the fourth face key point, the sample texture map, and the sample normal map to determine the fourth face image.

17. A non-transitory computer-readable storage medium having computer program instructions stored thereon, wherein the computer program instructions, when executed by a processor, cause the processor to:
perform a key point detection on a face image to be processed to obtain first specific key point data;
determine a first face feature vector corresponding to the face image to be processed;
generate initial digital face data based on the first face feature vector, and updating the initial digital face data with the first specific key point data to obtain three-dimensional digital face data; and
process the three-dimensional digital face data by digital human generation software, to obtain a target three-dimensional digital human.

18. The non-transitory computer-readable storage medium according to claim 17, wherein the first specific key point data comprises coordinates of first specific key points, the initial digital face data comprises coordinates of initial three-dimensional face key points, and the instructions further cause the processor to:
replace coordinates of initial three-dimensional face key points corresponding to the first specific key points with coordinates of the first specific key points to obtain the three-dimensional digital face data.

19. The non-transitory computer-readable storage medium according to claim 17, wherein the instructions further cause the processor to:
perform a first segmentation operation on the face image to be processed to obtain a first face segmentation result; and
determine the first face feature vector from the first face segmentation result.

20. The non-transitory computer-readable storage medium according to claim 17, wherein the first face feature vector comprises: a first reflection feature vector, a first detail feature vector, a first posture feature vector, and a first expression feature vector, and the instructions further cause the processor to:
obtain a normal map based on the first detail feature vector, the first posture feature vector, and the first expression feature vector; and
obtain a texture map based on the first reflection feature vector.
